(19) United States
(12) Patent Application Publication
(10) Pub. No.: US 2011/0184324 A1
(43) Pub. Date: Jul. 28, 2011

(54) MASSAGE DEVICE

(75) Inventors: Chichun Wu, Dongguan (CN); Zhao Zhang, Dongguan (CN)

(73) Assignee: WEIGHTEC ELECTRONIC TECHNOLOGY CO., LTD.

(21) Appl. No.: 13/080,529

(22) Filed: Apr. 5, 2011

Related U.S. Application Data
(63) Continuation-in-part of application No. 12/551,078, filed on Aug. 31, 2009.
Application No. 12/551,078 is a continuation-in-part of application No. 11/625,255, filed on Jan. 19, 2007, now Pat. No. 7,731,672.
Application No. 11/625,255 is a continuation-in-part of application No. 11/082,016, filed on Mar. 16, 2005, now abandoned.
Application No. 11/082,016 is a continuation-in-part of application No. 12/103,785, filed on Apr. 16, 2008.
(60) Provisional application No. 61/378,568, filed on Aug. 31, 2010.

(30) Foreign Application Priority Data
May 11, 2004 (CN) 2004200456092
Mar. 7, 2008 (CN) 200820091616.4
Jul. 10, 2009 (CN) 200920133730.3

(51) Int. Cl. A61H 15/00

(52) U.S. Cl. 601/112

(57) ABSTRACT

In one aspect of the present invention, a massage device includes a base cover, a carriage movably engaged with the base cover, a kneading assembly mounted on the carriage, and an up-down movement assembly that allows the carriage to move up and down along a longitudinal axis of the carriage. The kneading assembly includes a motor, a worm coaxially coupled to the motor, a first worm wheel meshing with the worm, and a cylindrical rod coaxially coupled to the first worm wheel. The cylindrical rod has a first end and an opposite, second end. The kneading assembly further includes a pair of eccentric wheels, each of which is coaxially coupled to the cylindrical rod at a respective end thereof. Mounted on each disk is a wheel-type massage head with a plurality of protrusions thereon. In operation, the motor drives, in sequence, the worm, the first worm wheel, the cylindrical rod, and the pair of massage heads, thereby providing rolling-like kneading effects to a part of a body under massage.

### CROSS-REFERENCE TO RELATED PATENT APPLICATION

This application claims priority to and the benefit of, pursuant to 35 U.S.C. §119(e), U.S. provisional patent application No. 61/378,568, filed on Aug. 31, 2010, entitled “MASSAGE DEVICE,” by Chichun Wu and Zhao Zhang, the disclosure of which is incorporated herein by reference in its entirety.

This application is a continuation-in-part of U.S. patent application Ser. No. 12/551,078, filed Aug. 31, 2009, entitled “MASSAGE DEVICE,” by Chichun Wu and Chi-Wu Chiang (“the '078 application”), which itself claims priority to and the benefit of, pursuant to 35 USC §119(a), Chinese patent application No. 200920133730.3, filed Jul. 10, 2009, entitled “A Massage Device with Massaging Feet,” by Chi-Wu Chiang, the disclosures of which are incorporated herein by reference in its entireties. The '078 application is a continuation-in-part of U.S. patent application Ser. No. 12/103,785, filed Apr. 16, 2008, entitled “A Massage Device,” by Chi-Wu Chiang, which itself claims priority to and the benefit of, pursuant to 35 USC §119(a), Chinese patent application No. 200820091616.4, filed Mar. 7, 2008, entitled “A Massage Device,” by Chi-Wu Chiang, the disclosures of which are incorporated herein by reference in its entireties. The '078 application is also a continuation-in-part of U.S. patent application Ser. No. 11/625,255, filed Jan. 19, 2007, entitled “Massage Device,” by Chi-Wu Chiang, now U.S. Pat. No. 7,731,672, which itself is a continuation-in-part of U.S. patent application Ser. No. 11/082,016, filed Mar. 16, 2005, entitled “Massage Device,” by Chi-Wu Chiang, now abandoned, which itself claims priority to and the benefit of, pursuant to 35 USC §119(a), Chinese patent application No. 2004200456092, filed May 11, 2004, the disclosures of which are incorporated herein by reference in its entireties.

### FIELD OF THE INVENTION

The present invention relates generally to a massage device, more particularly to a massage device having an up-down movement assembly and wheel-type massage heads.

### BACKGROUND OF THE INVENTION

With the improved living standard in modern times, people are experiencing faster social pace and higher levels of stress. To reduce stress, various ways of relaxation and exercise have become increasingly important in people's daily lives. In particular, massaging or kneading of parts of the body to aid circulation or relax the muscles has gained popularity. Massaging is usually performed either by a human or by a mechanical massage device. Human massaging requires highly experienced technicians and is usually performed in a special facility; therefore it is inconvenient and expensive. Most mechanical massage devices are relatively complex and costly.

Therefore, a heretofore unaddressed need exists in the art to address the aforementioned deficiencies and inadequacies.

### SUMMARY OF THE INVENTION

The present invention, in one aspect, relates to a massage device. In one embodiment, the massage device includes, among other things, a base cover, a carriage movably engaged with the base cover, a kneading assembly mounted on the carriage, and an up-down movement assembly.

In one embodiment, the kneading assembly includes, among other things, a motor, a worm coaxially coupled to the motor, a first worm wheel meshing with the worm, and a cylindrical rod coaxially coupled to the first worm wheel. The cylindrical rod has a first end and an opposite, second end. The kneading assembly further includes a pair of eccentric wheels. Each eccentric wheel is coaxially coupled to the cylindrical rod at a respective end thereof. Mounted on each disk is a wheel-type massage head with a plurality of protrusions thereon. In operation, the motor drives, in sequence, the worm, the first worm wheel, the cylindrical rod, and the pair of massage heads, thereby providing rolling-like kneading effects to a part of a body under massage. In one embodiment, the cylindrical rod is mounted on a pair of concave brackets via a pair of bearings. The pair of concave brackets are fixed to the carriage.

In one embodiment, the up-down movement assembly includes, among other things, a second worm wheel meshing with the worm, a first gear coaxially coupled to the second worm wheel, a first double gear meshing with the first gear, and a second double gear meshing with the first double gear and with a rock mounted in the base cover along a longitudinal axis thereof. In operation, the first motor drives, in sequence, the worm, the second worm wheel, the first gear, the first double gear, and the second double gear, thereby, causing the carriage to move up and down along the longitudinal axis of the base cover.

In another embodiment, the first double gear includes a second gear and a third gear. The second double gear includes a fourth gear and a fifth gear. The second gear meshes with the first gear, the third gear meshes with the fourth gear, and the fifth gear meshes with the rock.

In a further embodiment, the massage device further includes a top cover. The top cover mates with the base cover to enclose, among other things, the carriage, the kneading assembly, and the up-down movement assembly. The top cover has a plurality of openings adapted for allowing the pair of massage heads to protrude thereabove.

In another aspect, the present invention relates to a massage device. The massage device includes, among other things, a base cover, a carriage movably engaged with the base cover, a kneading assembly mounted on the carriage, a massage-head lateral movement assembly, and an up-down movement assembly. The up-down movement assembly is substantially the same as that for the massage device described above.

In one embodiment, the kneading assembly includes, among other things, a motor; a worm coaxially coupled to the motor, a first worm wheel meshing with the worm, and a first cylindrical rod coaxially coupled to the first worm wheel. The first cylindrical rod has a first end and an opposite, second end. The kneading assembly further includes a pair of elongated first gears. Each first gear is coaxially coupled to the first cylindrical rod at a respective end thereof. A pair of disks is coaxially coupled to each first gear. Mounted between each pair of disks is a wheel-type massage head with a plurality of protrusions thereon. In operation, the motor drives, in sequence, the worm, the first worm wheel, the first cylindrical rod, and the pair of massage heads, thereby providing rolling-like kneading effects to a part of a body under massage. In one embodiment, the first cylindrical rod is mounted on a pair of concave brackets via a pair of bearings. The pair of concave brackets is fixed to the carriage.

In another embodiment, the massage-head lateral movement assembly includes, among other things, a second worm wheel meshing with the worm, a second gear meshing with the second worm wheel, and a second cylindrical rod coaxially coupled to the second gear. The second cylindrical rod has a first end and an opposite, second end. The massage-head lateral movement assembly further includes a pair of cylindrical blocks. Each block is coupled to the second cylindrical rod at a respective end thereof. Each block has a slanted groove thereon configured to receive a respective pair of disks located at the two sides of a corresponding massage head. In operation, the motor drives, in sequence, the worm, the second worm wheel, the second gear, the second cylindrical rod, the pair of blocks, and the two pairs of disks, thereby causing each of the pair of massage heads mounted between the corresponding pair of disks to move laterally along the second cylindrical rod.

In a further embodiment, the massage device further includes a top cover. The top cover mates with the base cover to enclose, among other things, the carriage, the kneading assembly, the massage-head lateral movement assembly, and the up-down movement assembly. The top cover has a plurality of openings adapted for allowing the pair of massage heads to protrude thereabove.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numerals are used throughout the drawings to refer to the same or like elements of an embodiment, and wherein:

FIG. 1 shows an exploded view of a massage device according to one embodiment of the present invention;

FIG. 2 shows a perspective view of the massage device shown in FIG. 1 when it is assembled;

FIG. 3 shows a perspective view of the carriage as a part of the massage device shown in FIG. 1;

FIG. 4 shows an exploded view of a massage device according to another embodiment of the present invention;

FIG. 5 shows a perspective view of the massage device shown in FIG. 4 when it is assembled; and

FIG. 6 shows a perspective view of the carriage as a part of the massage device shown in FIG. 4.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

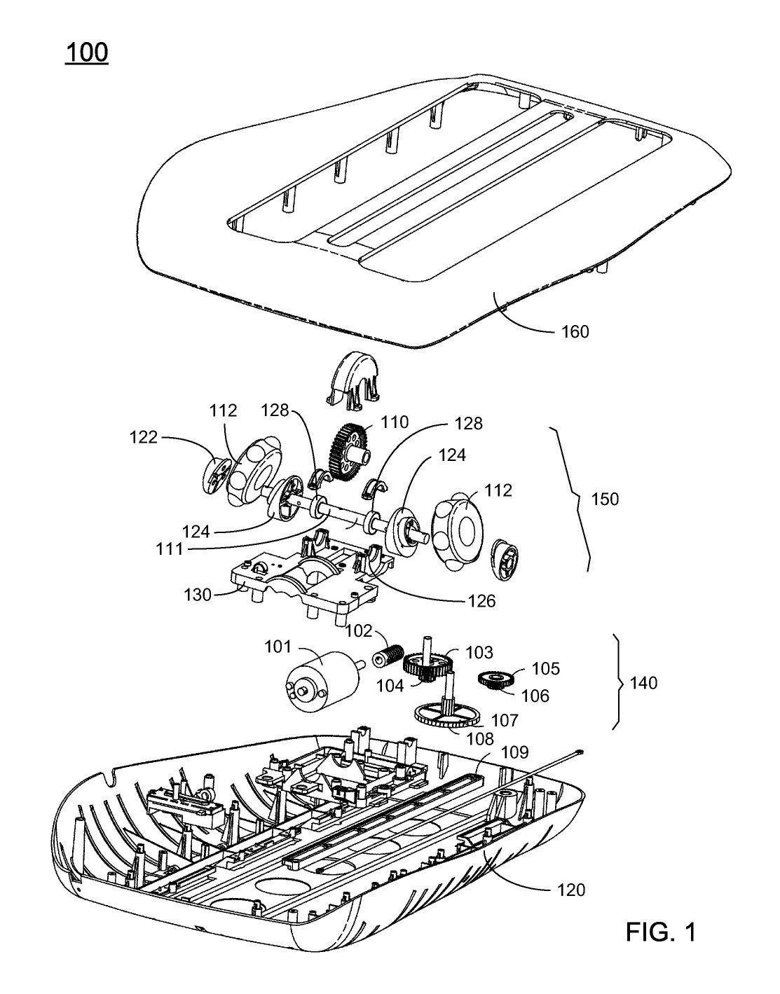

Embodiments of the present invention will be described in conjunction with the accompanying drawings in FIGS. 1-6. In accordance with the purposes of this invention, as embodied and broadly described herein, this invention, in one aspect, relates to a massage device.

FIG. 1 shows an exploded view of a massage device according to one embodiment of the present invention. The massage device 100 includes, among other things, a base cover 120, a carriage 130 movably engaged with the base cover 120, a kneading assembly 150, and an up-down movement assembly 140. The kneading assembly 150 and the up-down movement assembly 140 are mounted on the carriage 130.

In this exemplary embodiment, the kneading assembly 150 includes, among other things, a motor 101, a worm 102 coaxially coupled to the motor 101, a first worm wheel 110 meshing with the worm 102, and a cylindrical rod 111 coaxially coupled to the first worm wheel 110. The cylindrical rod 111 has a first end and an opposite, second end, and is mounted on a pair of concave brackets 126 via a pair of bearings 128. The pair of concave brackets 126 is fixed to the carriage 130. The kneading assembly 150 further includes a pair of eccentric wheels (wedge-shaped disks) 124. Each eccentric wheel 124 is coaxially coupled to the cylindrical rod 111 at a respective end thereof. Mounted on each eccentric wheel 124 is a wheel-type massage head 112 with a plurality of protrusions thereon. The wheel-type massage head 112 in turn is secured by an eccentric block having a wedge-type cylinder body 122. The details of the eccentric wheel (wedge-shaped disks) 124 and the eccentric block 122 are referred to U.S. patent application Ser. No. 12/103,785, now U.S. patent publication No. 2009/0227915, the disclosure of which is incorporated herein by reference in its entirety.

In operation, the motor 101 drives, in sequence, the worm 102, the first worm wheel 110, and the cylindrical rod 111, and thus the eccentric wheel 124. The rotation of the eccentric wheel 124 will drive the pair of massage heads 112 to gyrate in a way of which the central axis of the massage heads 112 rotates around the cylindrical rod 111 in an angle greater than zero. Such a gyro rotation of the massage heads 112 provides rolling-like kneading effects to a part of a body under massage.

Additionally, the up-down movement assembly 140 of the massage device 100 includes, among other things, a second worm wheel 103 meshing with the worm 102, a first gear 104 coaxially coupled to the second worm wheel 103, a second gear 105 of a first double gear 105/106 meshing with the first gear 104, a fourth gear 107 of a second double gear 107/108 meshing with a third gear 106 of the first double gear 105/106, and a fifth gear 108 of the second double gear 107/108 meshing with a rock 109 mounted in the base cover 120 along a longitudinal axis thereof. In operation, the motor 101 drives, in sequence, the worm 102, the second worm wheel 103, the first gear 104, the second gear 105 of the first double gear 105/106, the third gear 106 of the first double gear 105/106, the fourth gear 107 of the second double gear 107/108, and the fifth gear 108 of the second double gear 107/108, thereby causing the carriage 130 to move up and down along the longitudinal axis of the base cover 120.

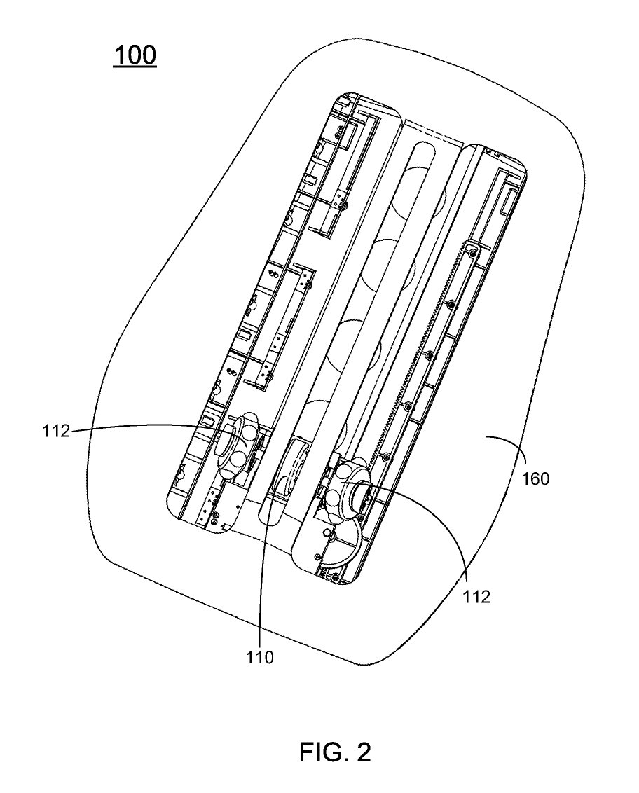

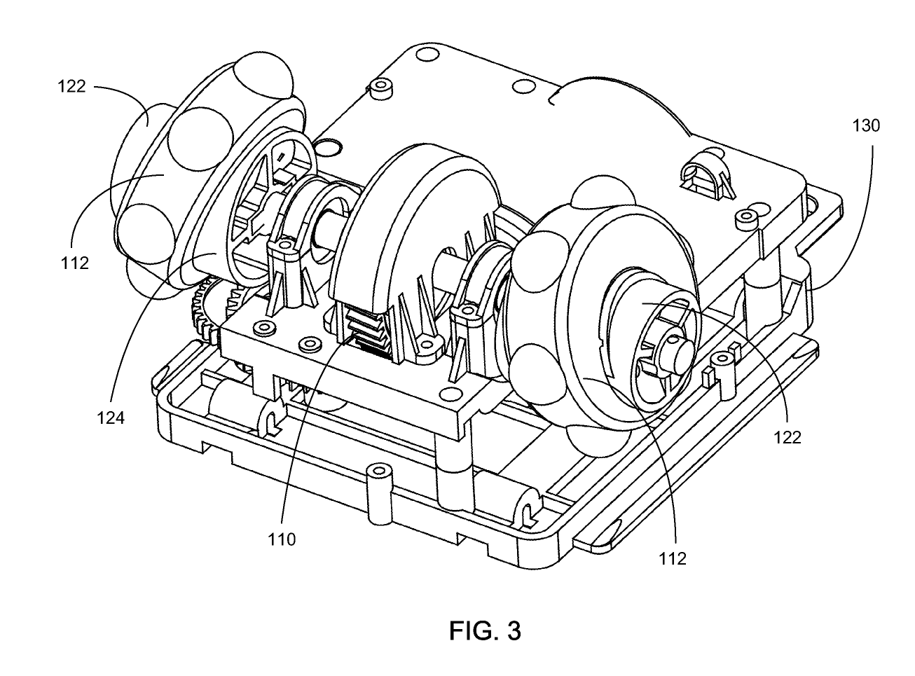

FIG. 2 shows a perspective view of the massage device shown in FIG. 1 when it is assembled. FIG. 3 shows a perspective view of the carriage as a part of the massage device shown in FIG. 1. In one embodiment, the massage device 100 further includes a top cover 160 that mates with the base cover 120 to enclose, among other things, the carriage 130, the kneading assembly 150, and the up-down movement assembly 140. The top cover 160 has a plurality of openings adapted for allowing the pair of massage heads 112 to protrude thereabove.

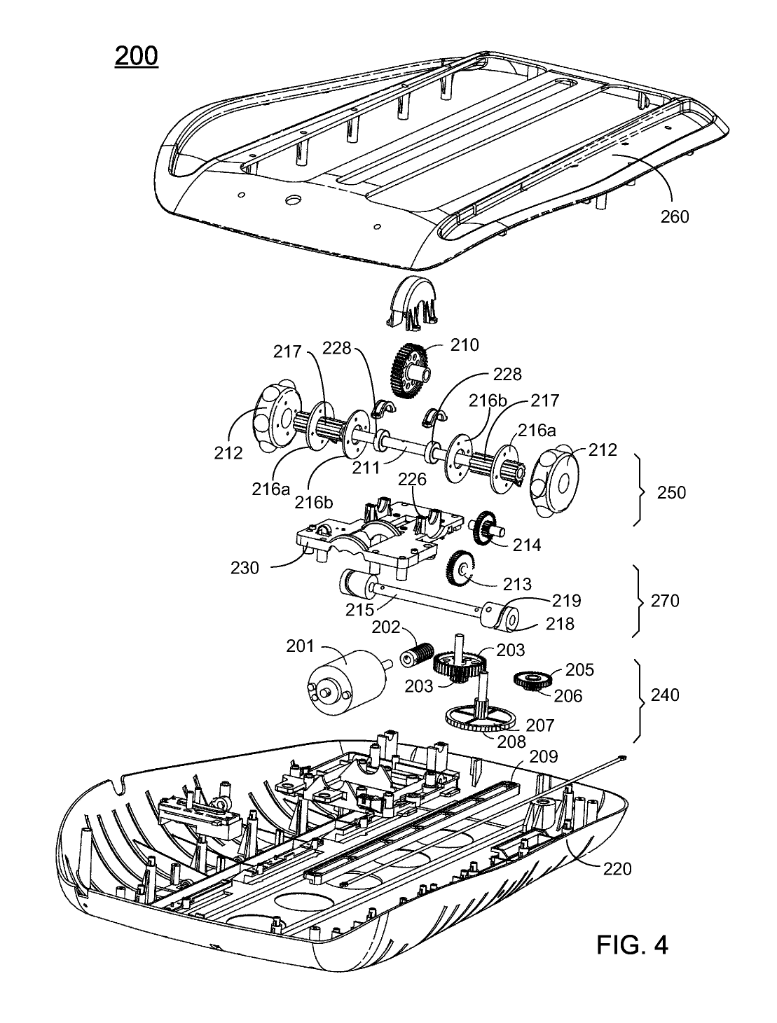

FIG. 4 shows a massage device 200 according to another embodiment of the present invention. The massage device 200 includes, among other things, a base cover 220, a carriage 230 movably engaged with the base cover 220, a kneading assembly 250 mounted on the carriage 230, a massage-head lateral movement assembly 270, and an up-down movement assembly 240. The kneading assembly 250 includes, among other things, a motor 201, a worm 202 coaxially coupled to the motor 201, a first worm wheel 210 meshing with the worm 202, and a first cylindrical rod 211 coaxially coupled to the first worm wheel 210. The first cylindrical rod 211 has a first end and an opposite, second end, and is mounted on a pair of concave brackets 226 via a pair of bearings 228. The pair of concave brackets 226 is fixed to the carriage 230. The kneading assembly 250 further includes a pair of elongated first gears 217. Each elongated first gear 217 is coaxially coupled to the first cylindrical rod 211 at a respective end thereof. A pair of disks 216a/216b is coaxially coupled to each first gear 217. A wheel-type massage head 212 is mounted between each pair of disks 216a/216b on a respective first gear 217. Each massage head 212 has a plurality of protrusions thereon. In operation, the motor 201 drives, in sequence, the worm 202, the first worm wheel 210, the first cylindrical rod 211, and the pair of massage heads 212, thereby, providing rolling-like kneading effects to a part of a body under massage.

In this exemplary embodiment, the massage-head lateral movement assembly 270 includes, among other things, a second worm wheel 213 meshing with the worm 202, a second gear 214 meshing with the second worm wheel 213, and a second cylindrical rod 215 coaxially coupled to the second gear 214. The second cylindrical rod 215 has a first end and an opposite, second end. The massage-head lateral movement assembly 270 further includes a pair of cylindrical blocks 218, each of which is coupled to the second cylindrical rod 215 at a respective end thereof. Each cylindrical block 218 has a slanted groove 219 thereon configured to receive a respective pair of disks 216a/216b. In operation, the motor 201 drives, in sequence, the worm 202, the second worm wheel 213, the second gear 214, the second cylindrical rod 215, the pair of blocks 218, and the two pairs of disks 216a/216b, thereby causing each of the pair of massage heads 212 mounted between the corresponding pair of disks 216a/216b to move laterally along the second cylindrical rod 215.

In one embodiment, the up-down movement assembly 240 includes, among other things, a third worm wheel 203 meshing with the worm 202 a third gear 204 coaxially coupled to the third worm wheel 203, a fourth gear 205 of a first double gear 205/206 meshing with the third gear 204, a fifth gear 206 of the first double gear 205/206 meshing with a sixth gear 207 of a second double gear 207/208, and a seventh gear 208 of the second double gear 207/208 meshing with a rock 209 mounted in the base cover 220 along a longitudinal axis thereof. In operation, the first motor 201 drives, in sequence, the worm 202, the third worm wheel 203, the third gear 204, the fourth gear 205 of the first double gear 205/206, the fifth gear 206 of the first double gear 205/206, the sixth gear 207 of the second double gear 207/208, and the seventh gear 208 of the second double gear 207/208, thereby causing the carriage 230 to move up and down along the longitudinal axis of the base cover 220.

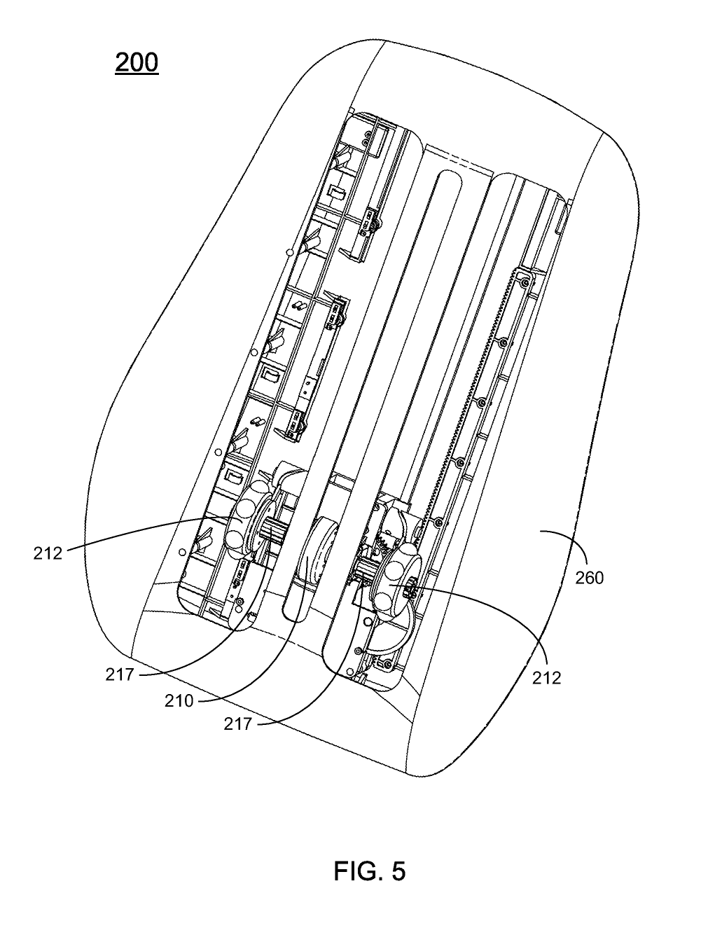

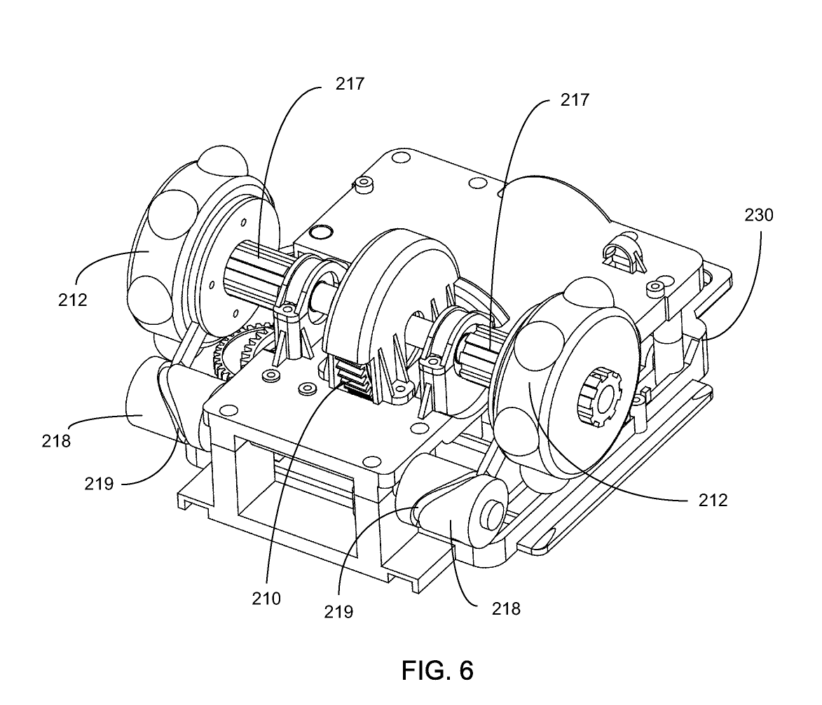

FIG. 5 shows a perspective view of the massage device shown in FIG. 4 when it is assembled. FIG. 6 shows a perspective view of the carriage as a part of the massage device shown in FIG. 4. In one embodiment, the massage device 200 further includes a top cover 260 that mates with the base cover 220 to enclose, among other things, the carriage 230, the kneading assembly 250, the massage-head lateral movement assembly 270, and the up-down movement assembly 240. The top cover 260 has a plurality of openings adapted for allowing the pair of massage heads 212 to protrude thereabove.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A massage device comprising:
(a) a base cover having a rock mounted therein along a longitudinal axis thereof;
(b) a carriage movably engaged with the base cover via the rock; and
(c) a kneading assembly mounted on the carriage, the kneading assembly comprising:
a motor;
a worm coaxially coupled to the motor;
a first worm wheel meshing with the worm;
a cylindrical rod coaxially coupled to the first worm wheel, the cylindrical rod having a first end and an opposite, second end;
a pair of eccentric wheels, each eccentric wheel being coaxially coupled to the cylindrical rod at a respective end thereof; and
a pair of wheel-type massage heads, each massage head being mounted on a respective eccentric wheel and having a plurality of protrusions thereon,
wherein, in operation, the motor drives, in sequence, the worm, the first worm wheel, the cylindrical rod and the eccentric wheels to rotate, wherein the rotation of the eccentric wheels drive the pair of massage heads to gyrate in a way of which the central axis of the massage heads rotates around the cylindrical rod in an angle greater than zero, thereby providing rolling-like kneading effects to a part of a body under massage.

2. The massage device of claim 1, further comprising an up-down movement assembly, the up-down movement assembly comprising:
(a) a second worm wheel meshing with the worm;
(b) a first gear coaxially coupled to the second worm wheel;
(c) a first double gear meshing with the first gear; and
(d) a second double gear meshing with the first double gear and with the rock mounted in the base cover,
wherein, in operation, the first motor drives, in sequence, the worm, the second worm wheel, the first gear, the first double gear, and the second double gear, thereby causing the carriage to move up and down along the longitudinal axis of the base cover.

3. The massage device of claim 2, wherein the first double gear comprises a second gear and a third gear, and the second double gear comprises a fourth gear and a fifth gear; and wherein the second gear meshes with the first gear, the third gear meshes with the fourth gear, and the fifth gear meshes with the rock.

4. The massage device of claim 2, further comprising a top cover adapted for mating with the base cover to enclose the carriage, the kneading assembly, and the up-down movement assembly, the top cover having a plurality of openings adapted for allowing the pair of massage heads to protrude thereabove.

5. The massage device of claim 1, wherein the cylindrical rod is mounted on a pair of concave brackets via a pair of bearings, the pair of concave brackets being fixed to the carriage.

6. A massage device, comprising:
(a) a base cover having a rock mounted therein along a longitudinal axis thereof;
(b) a carriage movably engaged with the base cover via the rock;
(c) a kneading assembly mounted on the carriage, the kneading assembly comprising:
a motor;
a worm coaxially coupled to the motor;
a first worm wheel meshing with the worm;
a first cylindrical rod coaxially coupled to the first worm wheel, the first cylindrical rod having a first end and an opposite, second end;
a pair of elongated first gears, each first gear being coaxially coupled to the first cylindrical rod at a respective end thereof;
two pairs of disks, each pair of disks being coaxially coupled to a respective first gear; and
a pair of wheel-type massage heads, each massage head being mounted between a respective pair of disks and having a plurality of protrusions thereon,
wherein, in operation, the motor drives, in sequence, the worm, the first worm wheel, the first cylindrical rod, and the pair of massage heads, thereby providing rolling-like kneading effects to a part of a body under massage; and
(d) a massage-head lateral movement assembly mounted on the carriage, the massage-head lateral movement assembly comprising:
a second worm wheel meshing with the worm;
a second gear meshing with the second worm wheel;
a second cylindrical rod coaxially coupled to the second gear, the second cylindrical rod having a first end and an opposite, second end; and
a pair of cylindrical blocks, each block being coupled to the second cylindrical rod at a respective end thereof and having a slanted groove thereon configured to receive a respective pair of disks,
wherein, in operation, the motor drives, in sequence, the worm, the second worm wheel, the second gear, the second cylindrical rod, the pair of blocks, and the two pairs of disks, thereby causing each of the pair of massage heads mounted between the corresponding pair of disks to move laterally along the second cylindrical rod.

7. The massage device of claim 6, further comprising an up-down movement assembly mounted on the carriage, the up-down movement assembly comprising:
(a) a third worm wheel meshing with the worm;
(b) a third gear coaxially coupled to the third worm wheel;
(c) a first double gear meshing with the third gear; and
(d) a second double gear meshing with first double gear and with the rock mounted in the base cover,
wherein, in operation, the first motor drives, in sequence, the worm, the third worm wheel, the third gear, the first double gear, and the second double gear, thereby causing the carriage to move up and down along the longitudinal axis of the base cover.

8. The massage device of claim 7, wherein the first double gear comprises a fourth gear and a fifth gear, and the second double gear comprises a sixth gear and a seventh gear; and wherein the fourth gear meshes with the third gear, the fifth gear meshes with the sixth gear, and the seventh gear meshes with the rock.

9. The massage device of claim 7, further comprising a top cover adapted for mating with the base cover to enclose the carriage, the kneading assembly, the massage-head lateral movement assembly, and the up-down movement assembly, the top cover having a plurality of openings adapted for allowing the pair of massage heads to protrude thereabove.

10. The massage device of claim 6, wherein the first cylindrical rod is mounted on a pair of concave brackets via a pair of bearings, the pair of concave brackets being fixed to the carriage.
